(19) United States
(12) Patent Application Publication
(10) Pub. No.: US 2015/0282456 A1
(43) Pub. Date: Oct. 8, 2015

(54) PET CARE SYSTEM WITH DISPOSABLE CARTRIDGE

(71) Applicant: John C. HARLEY, Santa Barbara, CA (US)

(72) Inventor: John C. HARLEY, Santa Barbara, CA (US)

(73) Assignee: John C. HARLEY, Santa Barbara, CA (US)

(21) Appl. No.: 14/246,164

(22) Filed: Apr. 7, 2014

(51) Int. Cl. A01K 27/00; B65H 16/00; E01H 1/12

(52) U.S. Cl. CPC A01K 27/008; A01K 27/004; A01K 27/006; A01K 27/009; E01H 1/1206; B65H 16/005; E01H 2001/1273; E01H 2001/128; E01H 2001/1286

(57) ABSTRACT

A pet care system is disclosed which may include disposable cartridges for storing and dispensing pet care consumable items. The cartridges may be detachably held in a main structure which may also include a retractable leash, and other pet care related items. The cartridges may have machine-readable indicia affixed thereto, that can point the user to information for ordering cartridges and supplies. The pet care system may have additional features to enhance the safety or convenience of the pet or user, including an RFID tag, a radio transmitter, a radio receiver, a GPS locator, a mechanism for generating audible sounds, a light emitting diode, and a flashlight.

### CROSS REFERENCE TO RELATED APPLICATIONS

Not applicable.

### STATEMENT REGARDING FEDERALLY SPONSORED RESEARCH

Not applicable.

### STATEMENT REGARDING MICROFICHE APPENDIX

Not applicable.

### BACKGROUND

This invention relates to a pet care product which dispenses pet care consumables.

Pet owners routinely take their pets on walks, usually on leashes in urban and suburban areas, and sometimes off-leash in rural areas and parks where allowed. Many public parks and private properties may allow pets but strictly prohibit the leaving of pet waste on the grounds. For this reason, pet owners are required to carry pet waste bags on their person, to collect and properly dispose of the waste their pets leave behind. In addition, many owners will carry pet treats with them, to aid in training, to call a pet back when it has strayed, and in general to reward their pets for good behavior. In addition to purses, car keys, cell phones, leashes, the pet owner may be encumbered may having to maintain possession of numerous pet-related items while walking the pet.

While pet owners can carry these waste bags and treats in their pockets or purses, it is inconvenient, because it involves individually selecting pet bags and small amounts of treats to stock one's pocket or purse on a routine basis. Thus, there is a need for a system to make this more convenient.

There have been a number of methods developed to do this, with varying degrees of success. For example, several leashes exist that integrate a compartment for holding treats, water, pet waste bags, or even used pet waste bags. Among them are U.S. Pat. No. 8,347,825, filed Sep. 13, 2010, U.S. Pat. No. 6,076,717, filed Apr. 13, 1998, and WO2010/019842, published Feb. 18, 2010, disclose leashes with specific compartments and containers. Others disclose leashes with hollow handles for storing consumables, such as U.S. Pat. No. 8,061,305, filed Sep. 28, 2006, US Patent Application Publication Serial No. 2008/0006223, published Jan. 10, 2008 and WIPO Application Publication Serial No. WO2008/039939 A3, published Apr. 3, 2008. While a step forward, these are still not as convenient as they could be, as they still require manual loading of the individual bags and treats into a compartment.

### SUMMARY

None of the prior art references discloses a pet care product with a convenient method for storing, dispensing and refilling a steady supply of a variety of pet care consumables.

Described here is a system for storing and dispensing pet care consumables which uses disposable canisters or cartridges that contain pet treats or other supplies. The system further provides a means to easily dispense these supplies as desired. Other cartridges, which may hold both pet waste disposal bags and/or pet treats, may also be included in the system. When exhausted, the cartridges can easily be separated from the system and replenished, or replaced with new, filled cartridges.

The system itself and/or the cartridges may further have machine-readable bar codes affixed to them. These bar codes can be used with a bar code reader, or other web enabled identifying device such as a cell phone, smart phone, tablet or laptop computer, to direct the user to a website where supplies can be purchased. These bar codes also may enable a variety of pet care consumable cartridges to be purchased at retail outlets.

Embodiments of the novel pet care system may be made up of any combination of these possible elements including the cartridges and holders as a separate unit, or in combination with a pet leash and handle. As a separate unit, the system may be attached by strap, loop, clasp or belt to a user's person, carried in a purse or pocket, on a conveyance, or on a pet collar. In the leash embodiment, the disposable cartridges may be held in a structure along with a retractable pet leash affixed to the collar of the pet.

With any of these embodiments, the user can easily purchase cartridges containing a variety of pet care materials such as pet waste collection bags and pet treats. These cartridges may be easily loaded onto the pet care system and easily detachable therefrom. The consumables may be individually dispensed from their cartridges by a lever or other mechanism. Alternatively, the dispensing mechanism may be configured to dispense a number of treats. The empty cartridges may be easily removed from the system and disposed of and the next cartridge may be attached in its place. The pet care system may also include at least one of the following; a pet training clicker device, a pet whistle, an RFID tag, a radio transmitter, a radio receiver, a GPS locator, a siren, a light emitting diode, a flashlight or any other device that improves the convenience or safety of the user and pet. At least one of these electrical devices may be in communication with a transmitter and/or receiver in the user's possession. A smart phone may serve as such a receiver. At least one battery may be included in the pet care system to power any electrical devices. The device may be compact, hand held or carried in a pocket or purse, and may have a maximum dimension not exceeding about 8 inches

Accordingly, the pet care product may comprise a structure with a holding mechanism. At least one disposable cartridge may fit in the holding mechanism but may be removable from the holding mechanism. Consumable pet care materials may be stored in the at least one disposable cartridge, wherein the at least one cartridge may be configured to dispense the consumable pet care materials. The consumable pet care materials may include at least one of pet waste collection bags and pet treats. Additionally the pet care system may further include a cartridge containing both pet waste collection bags and pet treats, wherein the waste bags may be wound around a hollow spool and pet treats may be stored inside the hollow spool.

### BRIEF DESCRIPTION OF THE DRAWINGS

Various exemplary details are described with reference to the following figures, wherein:

FIG. 1 is a perspective view of a separate unit embodiment of a pet care product with two disposable cartridges held in holding devices and with dispensing levers, a button and many other possible items;

FIG. 2 is a perspective view from the right side of a second embodiment, a retractable pet leash with a disposable cartridge in a holding mechanism with plunger and flap and many other possible items ;

FIG. 3 is an exploded perspective view from the right, of the second embodiment, a retractable pet leash, showing both sides of the clamshell like halves of the leash handle, the leash reel, two disposable cartridges, one cartridge holding mechanism, a plunger, flap, and other possible items;

FIG. 4 is an exploded view from the left, of a retractable pet leash showing two different pet care cartridges, one cartridge holding mechanism, a plunger, flap, and other possible items;

FIG. 5a is a larger view of one possible type of disposable cartridge, for dispensing pet waste collection bags, with the possible inclusion of a hollow spool for the dispensing of pet treats as well; FIG. 5b is an exploded view of a cartridge which can dispense both pet treats and pet waste bags; and

FIG. 6 is an expanded view of another type of disposable cartridge, for dispensing pet treats.

### DETAILED DESCRIPTION

The present invention will be understood more fully from the following detailed description, and from the accompanying drawings, which however, should not be taken to limit the invention to the specific embodiments shown but are for explanation and understanding only. It should be understood that these drawings do not necessarily depict the structures to scale, and that directional designations such as “top,” “bottom,” “upper,” “lower,” “left” and “right” are arbitrary, as the device may be constructed and operated in any particular orientation. A single feature shown in the drawings may be used to represent multiple possible functionalities, as described below.

The systems described herein may be of use in the care and handling of pets or other creatures. In particular, they may be of use in the training, exercising or finding of (lost) pets. However it should be understood that these embodiments and their uses are exemplary only and that they may be useful for other than pets and for other purposes entirely.

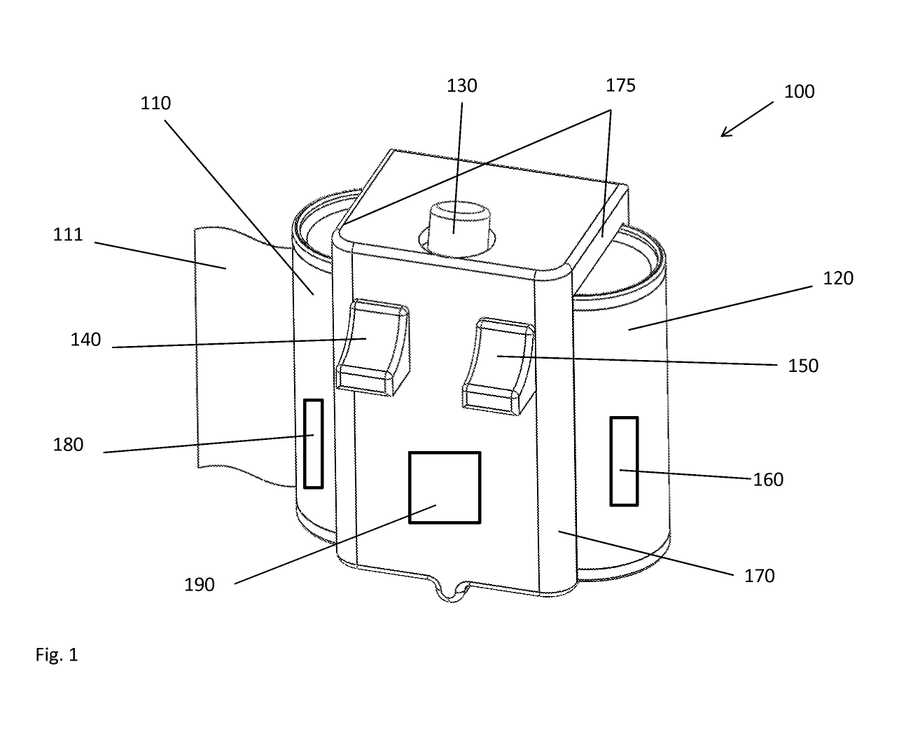

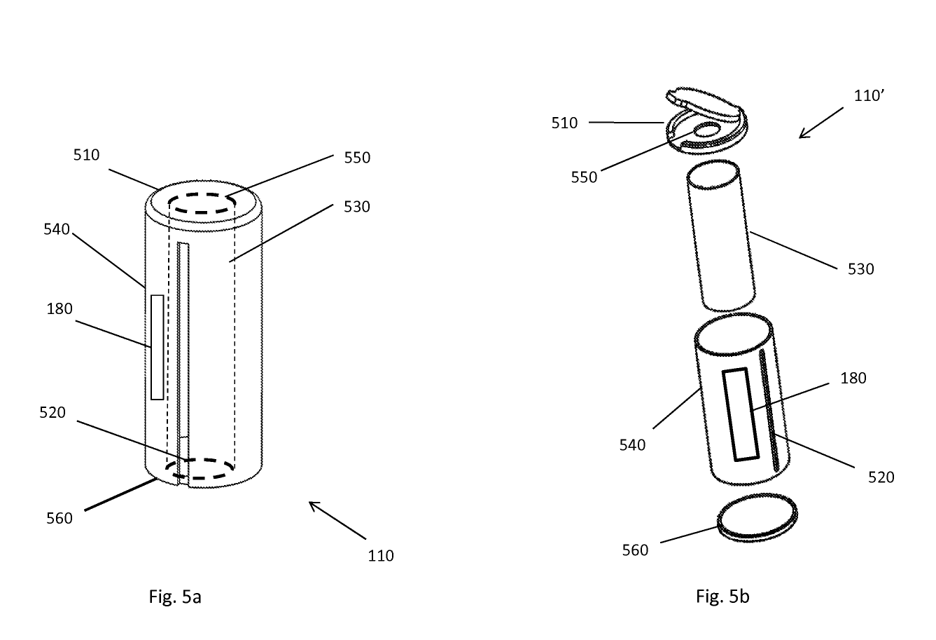

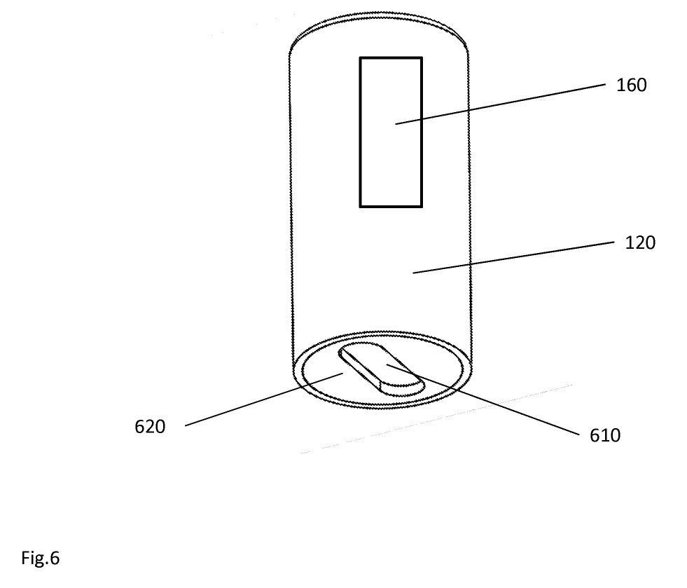

The system makes use of one or more disposable cartridges that store and dispense consumable pet care products. For example, the disposable cartridges may store and dispense pet treats or pet waste collection bags, or they may dispense both. These cartridges may be readily attached to or detached from one or more holding devices on any of the exemplary embodiments. Details relating to these exemplary embodiments of the pet care system are shown in FIGS. 1-4 and discussed with respect to those figures. Details relating to the disposable cartridge are described in detail with respect to FIGS. 5 and 6.

The user may readily dispense pet care consumables from a cartridge with a hand operated lever or other mechanism or by hand, and the method may depend on the type of consumable being dispensed. For example, waste bags may be dispensed one handed without the aid of a mechanism by simply pulling the bag from a spool wound with such bags. For the dispensing of treats, however, a dispensing device may be more convenient. This dispensing device may possibly be a lever or plunger attached to a pet care system and operable with the disposable cartridge.

A disposable cartridge may be replaced on the system when it runs out of materials or for some other reason. For example a different flavor of treat may be preferred by a different pet. Empty cartridges may conveniently be discarded. Replacing discarded cartridges or obtaining new or different ones is made more convenient by the use of bar coding to identify the possible wide variety of consumable products that fit the system. Purchase can be made at retail or on the internet with the use of a barcode reading device such as a smart phone, or other web- or internet-enabled device, such as a tablet or laptop computer.

The system may include other features which further increase the convenience and usefulness for pet handling. These other features may include a GPS locator, a transmitter or receiver or a flashlight may be included on the system. The pet care system 100 may further include audible devices which generate audible sounds for getting the attention of the pet. The audible sounds may be, for example, audible clickers, ultrasonic whistles or sirens. Finally, the system may include a power supply to power any of these features which are electronic in nature, or otherwise require power.

Various embodiments of the pet care system may be attached or affixed to the user or to the pet in various ways. In a first exemplary embodiment, shown in FIG. 1, the pet care system may include a main structural member that is coupled to a user or to the user's belt by a clasp or on a lanyard around the user's neck, or to a conveyance such as a wheelchair or bicycle, in a purse or pocket or directly on a pet collar. In a second exemplary embodiment, the pet care system may be coupled to the pet as with a leash. Further embodiments not mentioned here may become clear upon consideration of the following detailed description and accompanying claims.

FIG. 1 shows a simplified perspective view of the first exemplary embodiment of a pet care system 100. Pet care system 100 may be carried by the user in a variety of ways which will be described below. It may be made up of a main structural member 170 to which the other parts may be attached or fitted. The main structural member 170 may comprise at least one holding mechanism 175, which may hold at least one cartridge 110. The main structural member 170 may further comprise a second holding mechanism, also denoted 175, for a second disposable cartridge 120. The holding mechanisms 175 for holding the first disposable cartridge 110 and the second disposable cartridge 120 may be the same or they may be different.

It should be understood that pet care system 100 having two holding mechanisms is exemplary only, and that other pet care systems may be envisioned which have a plurality of holding mechanism for holding a plurality of disposable cartridges.

The holding mechanism 175 may be an integral part of the main structure 170, or it may be separately attachable to the main structure 170. The holding mechanism(s) 175 may securely but temporarily hold each cartridge 110 and 120 and may allow for the dispensing of the consumable materials loaded inside the cartridges. Holding mechanism 175 shown in FIG. 1 may simply be an interference fit between the cartridges 110 and 120 and a cavity formed in main structure 170 to accept cartridges 110 and 120. The cartridges 110 and 120 may thereby be removable from main structure 170 for disposing or reloading with the consumable pet care items. Two such consumable items are pet treats, which may be food, vitamins, supplements or other items that are appealing to the pet, and pet waste bags for storing pet waste for proper disposal.

The two disposable cartridges 110 and 120 are shown partially within the main structural member 170 and partially protruding from it on either side and may be held by the interference fit 175 mentioned above. This type of holding method may rely on the flexibility of the materials for a secure (snap) fit. Alternately, there may be a spring loaded hinged latch or arm that holds each cartridge in place. Each cartridge 110 or 120 may fit into a cylindrical shaped cavity built into the frame. They may be inserted into the main structural member 170 from above or from below to be held in place by gravity or with a spring mounted latch. The holding mechanism 175 may alternatively be a Velcro® like frictional attachment between two materials, one affixed to a cartridge and the other affixed to the main structural member 170 or it may make use of a threaded fastener with a thumb screw for convenience. With any of these or some other mechanism, the pet care system may allow for the easy attachment, secure holding and easy detachment of cartridges from the pet care system to enhance convenience for the user in dispensing pet care consumable materials.

Although two cartridges are shown in FIG. 1, it should be understood that the system may be designed to accommodate any number of disposable cartridges. The cartridges may be of the same size and be interchangeable in either holding mechanism or they may differ in size. The first cartridge, 110, may be loaded with pet waste collection bags and the second cartridge, 120, may be loaded with pet treats, for example, although the disposable cartridges 110 and 120 may be loaded with any of a number of other pet care consumables. Each of the cartridges may be configured to dispense their contents as operated by the user.

The method of dispensing the consumable pet care materials conveniently from the system shown in FIG. 1 may vary depending on the type of consumable being dispensed. The dispensing mechanism(s) may be configured to be operated by the user, to dispense the contents of the cartridges on demand. The dispensing mechanism for pet treats, for example, may be designed in such a way that treats are dispensed individually and with one hand. Alternatively, the dispensing mechanism may dispense a number of treats. As represented in FIG. 1 by dispensing mechanisms 140 and 150, the dispensing mechanisms may comprise plungers which may urge the contents of any type of cartridge outward or downward. The passageway storing the treats may have a funnel-like shape, to encourage the passing of the supply of pet treats to occur single-file. Alternatively, plunger 150 may open a flap at the bottom of cartridge 120 causing treats to be dispensed individually. Alternatively, the dispensing mechanism may be configured to dispense a number of treats.

In the case of pet waste collection bags 111, the plunger 140 may cause the contents of cartridge 110, possibly a roll of waste bags, to rotate, dispensing a single bag. Alternatively, the waste collection bags 111 may be loaded into the cartridge 110 in such a way that they may not require a dispensing mechanism 140. For example, pulling one bag 111 out of the cartridge 110 may position the next bag for subsequent removal. The bags 111 may be made up of a continuous roll with perforations between bags to make removal of each individual bag a convenient one-handed operation which may require no dispensing mechanism. Alternately dispensing mechanism 140 may hold the roll of bags inside the cartridge making it easier for the user to conveniently remove a single bag only. Or the waste bag dispensing mechanism 140 may need to be pressed to allow the internally stored roll of bags to rotate so the bags would be prevented from unraveling inadvertently until the dispenser lever 140 was pressed. Alternatively, dispensing mechanism 150 may open a flap at the bottom of cartridge 110 allowing the pet waste bags to be pulled from the bottom. Other alternative dispensing methods may be described with respect to FIGS. 5 and 6.

Although not shown specifically in FIG. 1, some attachment hardware may be provided for the possible attachment of pet care system 100 to a user or to a pet. This attachment hardware may comprise a reinforced point in the main structural member 170 (not shown) for the attachment of a strap or lanyard for hanging the system from the user's neck, or wrist, from the user's conveyance such as a bicycle. Alternately the attachment system may comprise belt or collar loops built into the back of the main structural member 170 for attachment to the user's belt, from a purse strap or to the pet's collar or harness. In yet another alternative, the main structural member 170 may include a belt clip that may clip to the belt, waist band or suspenders of a user, in a manner similar to a cell phone or smart phone case. As it may be convenient to carry pet care system 100 in a small bag or purse, pet care system 100 may be designed so that the main structural member 170 may be easy to remove, and so that the system may have no dimension in excess of 8 inches, and may be configured to be hand-held. Accordingly, pet care system 100 may be attached to the user, to an article of clothing, or to the pet. This list of possible implementations is exemplary only, and is not meant to be an exhaustive listing of the possible ways that pet care system 100 may be carried or used.

A button or knob, 130, may be disposed in the top of the main structural member 170. This button 130 may comprise part of a mechanism for generating audible sounds. This mechanism may comprise a clicker, a whistle, a horn or a siren, for example. If the mechanism 130 generates an audible sound, the sound may be mechanical or electronic in nature. A clicker may be used for pet training or calling, and the noise may become familiar to the pet as an indication that a particular behavior is expected. There may be more than one button or knob 130 on the main structural member 170, although only one is shown in FIG. 1.

In addition to the possible noise generating mechanism, there may be one or more electrical or other devices, 190. Devices 190 may include at least one of an RFID tag, a radio transmitter, a radio receiver, a siren, a GPS locator, a light emitting diode, a flashlight or any number of other useful devices. In the case of an RFID tag, a radio transmitter, a radio receiver, a GPS locator, a siren or a light emitting diode, or a flashlight, the device may be in communication with a receiver and/or transmitter in the user's possession which may communicate with or control the device 190. The device 190 may be activated by a transmitter and/or receiver on the user's person, for example. The electronic device 190 may also include logic or circuitry for controlling the various features in pet care system 100 in response to a user's electronic commands. The logic or circuitry may include a printed circuit board, a microprocessor, memory, or other electronic hardware housed in main structural member 170.

Electronic device 190 as shown on the main frame 170 may also comprise a battery, for powering at least one of an RFID tag, a radio transmitter, a radio receiver, a GPS locator, a siren, a light emitting diode, or a flashlight. Additional buttons or knobs, 130, may be required to control one or more of the devices 190. These controls may be placed on the top or on the front of the main frame 170. Some possible electronic devices may require an antenna and this may be built into the main structural member 170 or it may be attached to a connector built into the main structural member 170. This list of possible mechanical or electronic devices 190 is exemplary only and is not meant to be an exhaustive listing of possible useful and convenient devices.

Accordingly, pet care system 100 may include a structure with a holding mechanism and a disposable cartridge 110 that is held by the holding mechanism but is removable from the holding mechanism. Consumable pet care materials may be stored in the disposable cartridge 110, wherein the disposable cartridge 110 is configured to dispense the consumable pet care materials. The consumable materials may comprise at least one of pet waste bags 111 and pet treats. Pet care system 100 may further include a plurality of mechanisms for holding a plurality of disposable cartridges 120. There may be indicia 160 and 180 on each cartridge 110 and 120, respectively, which may comprise a bar code readable by a barcode reader or cell phone.

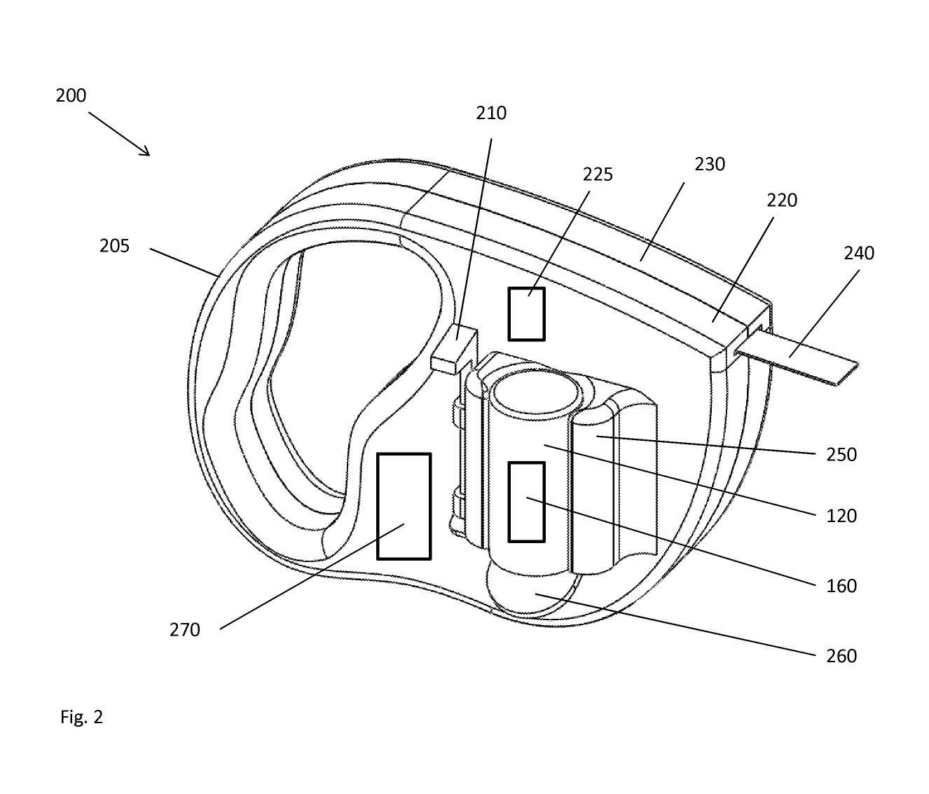

In a second exemplary embodiment, the pet care system may include the handle of a retractable flexible leash which may attach to the collar of the pet. This embodiment is shown in FIGS. 2-4 and described below.

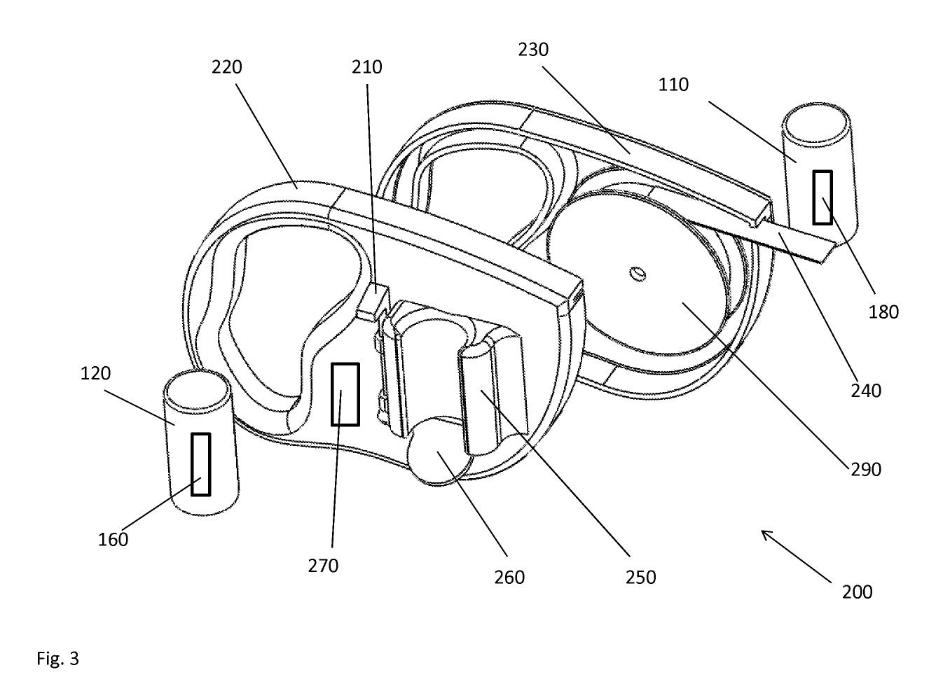

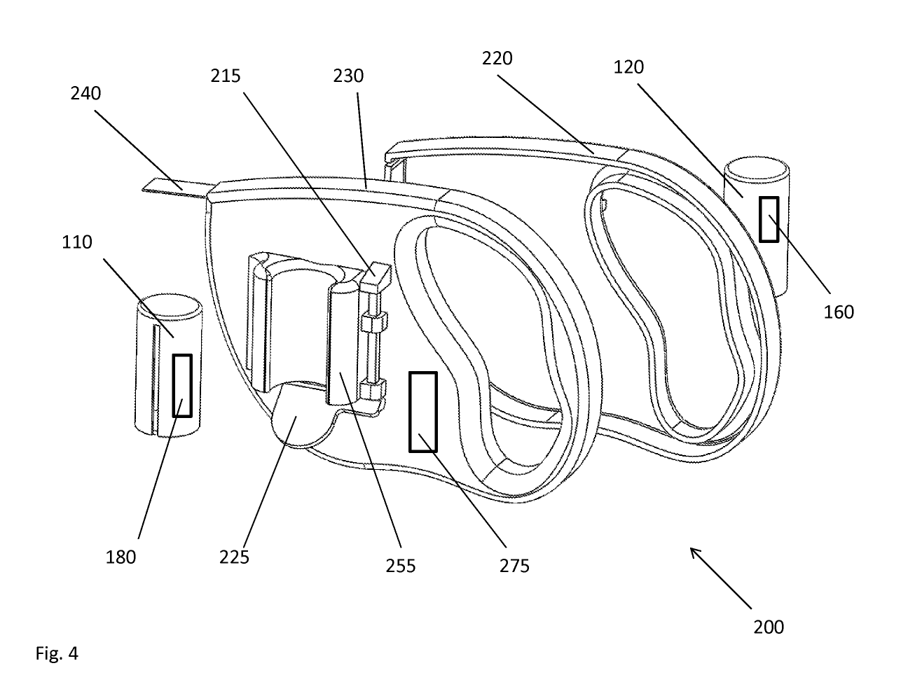

The second embodiment of the pet care system 200 is shown from both sides in FIGS. 2-4, and both fully assembled and in exploded views. Pet care system 200 may differ from system 100 shown above in that it may include a retractable pet leash designed to allow control of the pet by the pet owner. While the embodiment shown here may include a retractable leash, it should be understood that a non-retractable leash may also be used. It should be understood that any feature shown on one side of the pet care system 200 as shown in FIG. 2 may be alternatively or additionally mounted on the other side of pet care system 200 and vice versa. For example, item 270 shown on the right-hand-view of FIGS. 2 and 3 may be similar or identical to item 275 on the left-hand-view of FIG. 4, or it may be disposed on only one side of pet care system 200.

FIG. 2 is a perspective view of the right hand side of pet care system 200, in its assembled state. Pet care system 200 may include a pet leash 240 and several possible additional elements. The main structural member may be comprised of a right half 220 and a left half 230 joined together to form a clam shell like structure. That is, the main structure may be formed from two components that are snapped, glued, screwed or otherwise joined together as a clam shell. These sides may be manufactured and processed separately and then assembled into a one piece handle for a pet leash as shown in the figure. For example the two sides may each be injection molded, trimmed, and flattened on the mating surfaces and internal subassemblies may be added prior to being joined together. For example, the leash retraction spring mechanism or an antenna may be attached to one side 220 or 230 before final assembly. The possible method of manufacture and the materials will be described in more detail below.

Protruding from a slot in the upper right of the figure may be the flexible leash 240 which may exit from a point on the handle 205. The leash itself, be it nylon or metallic may be required to move in an out many times over its useful life. Therefore the leash may exit the handle through a short tube section of wear resistant material, possibly metallic or plastic, to extend the useful life of pet care system 200.

The leash 240 may connect to a pet at its opposite end from the handle 205. The leash 240 may be made of one section of a single type of material such as woven nylon webbing or it may combine several pieces of material such as metal chain and nylon. The several sections may be connected by metal swivel hooks, possibly detachable which may prevent twisting or tangling of the leash. The length of the leash may be variable and some or all of the leash material may be retracted into the leash for storage when not in use. The method of operation of the retraction mechanism will be described with respect to FIG. 3, below, which shows the retractable leash mechanism in an exploded view. The retraction mechanism may require a brake or other control on the handle, which for simplicity are not shown in FIGS. 2-4. Their function will be described in more detail below with respect to manufacturing and use of pet care system 100 and 200.

Shown on the side of pet care system 200 is a holding mechanism 250 for cartridge 120, with a dispensing plunger 210, and dispensing flap 260. Flap 260 may be manufactured from a flexible elastomeric material so that it will ordinarily close the hole in the bottom of cartridge 110 and such that plunger 210 may temporarily push it open allowing one treat to pass.

One pet treat consumables cartridge 120 is shown in the holding mechanism 250. There may be a holding mechanism 250 on either or both sides of the pet care system 200, such that another cartridge and associated holding and dispensing mechanism may be disposed on the other side of pet care system 200, but not seen in this view. The holding mechanism 250 on the right side of the handle may be attached to the handle 205 during the manufacturing process. If plastic it may be glued or attached with sonic welding. Parts of the holding mechanism 250 may be molded into the handle and the remainder glued on at assembly or it may be attached with screws or by some other method. While the holding mechanism 250 may appear different from the similarly named device 175 in FIG. 1, it may serve the same purpose and may work in the same or similar fashion.

The holding mechanism 250 may securely hold a consumables cartridge 120 in place allowing the cartridge 120 to be temporarily attached to the pet care system 200 and easily removed from it by the user at any time. As previously mentioned, the cartridge 120 may be held in place by an interference (snap) fit, designed to take advantage of the flexibility of the materials or it might fit into a cylindrical slot to be held in place by gravity or by a spring loaded mechanism that would allow for secure holding and easy attachment and removal. There may be a spring loaded hinged member and a latch to secure the cartridge 120 in place. Other holding methods may use Velcro® or screws to hold the cartridge. The method may allow convenient attachment, secure holding and easy detachment from the system.

The cartridge 120 shown in FIG. 2 may be a pet treat cartridge. The type of cartridge may be identified by indicia 160, which may be machine-readable indicia such as a bar code or label. The consumable pet treats may be dispensed one by one, by the user with the lever (plunger), 210. A flap 260 may be part of the mechanism for exposing and dispensing the pet treats. The mechanism for dispensing pet treats individually may include a funnel like structure in the holding mechanism 250. This funnel may encourage a single treat to be in place to be dispensed, and prevent additional treats from dropping past the flap 260. Dispensing mechanism 210 for the pet treat cartridge 120 may connect to a lever that may block the movement of all but the lowest treat in the funnel as the flap opened and the individual treat dropped into the user's hand. Alternatively, the dispensing mechanism may be configured to dispense a number of treats.

The possible alternative types of cartridges and their locations may be the same on system 200 as they were on system 100. Likewise the alternatives for the uses of the dispensing plungers or mechanisms may be the same. The dispensing mechanism for a waste bag cartridge 110 which may be included on the left side of the system 200 may be very different or it may not be included at all. The dispensing mechanism for the cartridge 110 may also be different from the dispensing mechanism for treat cartridge 120 but either may dispense the treats and bags individually as was described above for system 100.

In addition to the holding mechanism 250 on the right side of pet care system 200 in FIG. 2, there may be one or more features 270 which may add various capabilities to pet care system 200. Feature 270 may be analogous to feature 190 in embodiment 100 shown in FIG. 1, and may represent additional functionalities of pet care system 200. Feature 270 may include an audible emitter for making a clicking or pet whistle sound for use in training or calling a pet. This audible device may be mechanical or electronic in nature. Other possible devices 270 may include at least one of an RFID tag, a radio transmitter, a radio receiver, a siren, a global positioning system (GPS) locator, a light emitting diode, a flashlight or any number of other useful devices. Devices capable of communication, such as the RFID tag, radio transmitter, a radio receiver, GPS locator may be in communication with a transmitter and/or receiver in the user's possession. These communication devices may assist the owner in locating the pet, should the owner lose control of the pet and/or the pet care system 100 or 200.

As with previous pet care system 100, electronic devices 270 as shown on the right side 220 of pet care system 200 may also include a battery, for powering at least one of the electronic components listed above. Electronic devices 270 may also include logic or circuitry for controlling the various features in pet care system 200 in response to a user's electronic commands. The logic or circuitry may include a printed circuit board, integrated circuit, a microprocessor, memory, or other electronic hardware housed in the main structure 220 and/or 230.

Additional buttons or knobs may be required to control the one or more devices 270 and/or the retracting mechanism, but for simplicity, are not shown in FIG. 2. These controls may be placed in any convenient place on either side of the pet care system 200. An internal wiring harness or printed circuit board may be used to connect the one or more devices 270. One additional such device may be a finger operated button or buttons that controls the retracting mechanism to which the flexible leash is connected. This control or controls may be located on the top of the handle in the middle between the two halves 220 and 230. These controls are described in the detailed description of the exploded view of FIG. 3, below.

FIG. 3 is an exploded view from the right side of pet care system 200. Many of the elements illustrated in FIG. 3 were previously described with respect to FIG. 2. In the interest of avoiding unnecessary repetition, only those new elements shown in FIG. 3 will be thoroughly described here, and the previously described elements will simply be identified here. In FIG. 3, both the right side 220 and the left side 230 of the clam shell like handle 205 of a retractable pet leash are clearly shown. These two sections may be manufactured separately as described further below. Previously described with respect to FIG. 2 are the holding mechanism 250, the dispensing mechanism 210, flap 260, and cartridge 120 with indicia 160. Also described in detail above were the one or more functionalities represented by device 270. These items may have a similar or identical function in FIG. 3 as was discussed with respect to FIG. 2. The switches or controls for devices 270 may be located on either side of the leash and devices such as antennae may be located inside the pet care system 200.

There are at least two additional elements of FIG. 3 relative to FIG. 2. A second cartridge 110 with barcode 180 and a leash retraction spring mechanism 290 may be contained within the pet care system 200. What follows is a discussion of the cartridge 110, the spring loaded leash retraction mechanism and the leash 240, itself.

The cartridge 110 shown in FIG. 3 with its indicia 180 has been described above with respect to FIG. 1. Likewise, second cartridge 120 may be the same or different than first cartridge 110. The existence of two cartridges 110 and 120 may imply that there is another holding mechanism 255 built into the left side 230 of the handle, but out of view. Holding mechanism 255 may be essentially like holding mechanism 250 and will be illustrated in the left-side view of FIG. 4. For example, holding mechanism 255 may be an interference (snap) fit, like holding mechanism 250. Either first cartridge 110 or second cartridge 120 may be one of three types of cartridges, a waste bag, a pet treat or a dual waste bag and pet treat cartridge.

Like pet care system 100, it should be understood that pet care system 200 having two holding mechanisms is exemplary only, and that other pet care systems may be envisioned which have a plurality of holding mechanism for holding a plurality of disposable cartridges. There may be any number of holding mechanisms for holding any number of disposable cartridges in pet care system 100 or 200, and the cartridges may be configured, mix and matched in any manner desired by the user. Exemplary sorts of cartridges which may be mixed and matches are described below with respect to FIGS. 5a, 5b and 6.

A spring loaded spool mechanism, 290 shown in FIG. 3 may comprise a retractable leash spool. The spool may contain a steel spiral leaf or retractor spring. The spring may be attached to both the spool and to the left side 230 of the handle such that the spring forces the spool to rotate counter clockwise. Most of the flexible leash 240 may be wrapped around the spool inside the leash when the spool has been fully retracted by the spring. The spring loaded spool may allow the leash to be pulled out of the handle to its full length and to be retracted into the handle to its minimum length. The spring mechanism and spool may be located within the clamshell handle and may be mounted on a metallic axle. The axle may fit into and be supported by bosses injection molded into both the right side 220 and the left side 230 of the handle.

The leash may be constructed with a flexible material such as woven nylon or polyester webbing (shown) or with flexible metal braided wire rope or chain. The leash may include a separate section near the pet end which may be made of a different material from the main retractable material. For example the main length of leash material, two to ten meters, may be flexible wire rope while the last 30 centimeter length may comprise a safety collar for reliable attachment to the pet and to the pet collar or harness. This shorter section may connect to the longer section of the leash with a swivel ring and may end with a spring hook or bolt snap. When retracted, all of the leash except the length of safety collar may be stored within the structure, 200. The swivel hook may prevent the shorter safety collar section from passing the wear ring at the entry point of the leash into the handle 205.

Devices 270 may include at least one thumb operated button for the mechanical control of the length of the flexible leash. One button may apply enough braking force to effectively stop and hold the leash against the pull of a pet. A second thumb operated button may prevent the leash length from changing. As such it may be a brake lock. These controls may be conveniently located near the natural position of the user's thumb on the handle 205 and may be in the middle of the closed (assembled) clam shell structure of the pet care system.

Also included in pet care system 200 may be a retractable pet leash 240 with a handle structure 205 designed to be grasped by the user's hand. The retractable leash 240 may be stored in the handle structure 205 and dispensed from the handle structure 205, and may also be attached to a collar of a pet. An additional mechanical feature may be a coupling mechanism 225 that couples the pet care system to a strap, loop, or belt on a user's person. The coupling mechanism 225 may comprise a reinforced, hard point built into the handle. This hard point may include a 10 mm wide metal loop (not shown). From this connecting point, a strap may be used to connect the system 200 securely to the user's person. This strap may be used to insure that the user does not lose control of the leash and control of the pet. The strap may be 75 centimeters long and it might have a chromed or stainless steel swivel clasp such as a spring hook, a bolt snap or swivel hook on each end. The coupling mechanism (10 mm wide hard point) on the handle may be large enough for the strap coupling mechanism to attach to it twice, turning the strap into a loop or lanyard. It can also be used to tie the leash to a stationary object in order to allow the user to keep the pet under control even while the user goes elsewhere.

FIG. 4 is an exploded view from the left, of a pet care system 200, showing two different pet care cartridges 110 and 120. In the left-side view, there may appear structures that have a similar or identical function to structures shown in the right-side view of FIG. 3. In these cases, reference numbers 2x5 in FIG. 4 may identify analogous features to reference numbers 2x0 of FIG. 3.

As shown in FIG. 4, pet care system 200 may include another cartridge holding mechanism 255, device 275, dispensing mechanism 215 and flap 225, which may correspond to holding mechanism 250, device 270, dispensing mechanism 210 and flap 220 shown in FIG. 3 and described above. Device 275, for example, may be the equivalent of device 270 on the right side of the handle in FIG. 3. Accordingly, device 275 may be the same or different than device 270, but may be selected from the group including an RFID tag, a radio transmitter, a radio receiver, a GPS locator, a siren, a mechanism for generating audible sounds, a light emitting diode, and flashlight, for example. For example, device 270 may be a mechanism for generating an audible sound, whereas device 275 may be a GPS locator.

The devices and controls here represented by devices 270 and 275 are shown located in specific places, however, it should be understood that they may be located anywhere on or inside the handle. It is possible that more than one voltage would be necessary and would entail the mounting of an additional battery or batteries in a holder on or inside the handle.

Holding mechanism 255 as shown in FIG. 4 may be the same as the equivalent 250 in FIGS. 2 and 3 and flap 225 and dispensing mechanism 215 may also be the same as their equivalents 220 and 210. Cartridge 110 which is shown with a slot for dispensing waste collection bags or treat cartridge 120 may be attached on either side of the handle. The cartridges and other associated mechanical parts such as the holding mechanism 255, plunger 215 and flap 225 may be larger on one side of the handle or there may only be one holding mechanism and a dual type cartridge. Accordingly, the pet care system illustrated in FIGS. 3 and 4 may comprise two holding mechanisms, one on each of the two portions 220 and 230, which are configured to securely hold two disposable cartridges for dispensing the consumable pet care materials.

In pet care system 200, each type of disposable cartridge 110 and 120 may further comprise machine readable indicia, 160 and 180, respectively, such as a bar code readable by a bar code reader or cell phone. The bar code may point to information to assist the ordering of replacement cartridges by a user.

Accordingly, pet care system 200 may be comprised of at least two disposable cartridges containing consumable pet care materials and wherein the pet care materials comprise at least one of pet waste collection bags and pet treats. This pet care system 200 may be a pet care product comprising a structure with a holding mechanism 250 and at least one disposable cartridge that fits securely in the holding mechanism 250 but is removable from the holding mechanism. Consumable pet care materials may be stored in the at least one disposable cartridge, wherein the at least one disposable cartridge is configured to dispense the consumable pet care materials.

The left side, 230, together with the right side, 220, may form a structure for mounting one or more holding mechanisms for the holding of one or more cartridges. Because the structure is designed to be hand held and to conveniently be stored in a purse, pocket of backpack, pet care system 100 or 200 may have no dimension in excess of 8 inches, 8 inches, and may be configured to be hand-held.

FIGS. 5a, 5b and 6 are detailed views of exemplary disposable cartridges 110, (FIG. 5a), 110′ (FIG. 5b) and 120 (FIG. 6), which may be used in pet care system 100 or 200. A first sort of cartridge 110 may be used to dispense extensive, flexible items such as napkins, waste bags, or tissues. A second sort of cartridge 120 may be used to dispense solid, singular items such as candies or pet treats. Exemplary cartridge 110 is illustrated in FIG. 5a, and exemplary cartridge 120 is illustrated in FIG. 6. A third sort of cartridge 110′ may store and dispense both sorts of items, by holding the singular items in a hollow cylinder within the cartridge, with the flexible item wound around the hollow spool. This type of cartridge is illustrated in FIG. 5b. Each of these sorts of disposable cartridges is described in detail below.

In the first sort of cartridge 110, shown in FIG. 5a, a larger, outer cylinder 540 in solid lines may be disposed around a smaller, inner cylinder 530 shown in dashed lines within it. There may be a slot 520 shown in the outside surface of the cylinder 540. In one embodiment of cartridge 110, the cylinder 540 may contain a wound roll of pet waste bags 111 which may be dispensed through a lengthwise slot 520 in cylinder 540. The smaller, inner cylinder 530 may be a shaft, spool or axle on which the pet waste bags 111 may be wound. In some embodiments, the pet waste bags 111 may simply be wound in a spiral fashion and placed inside the larger, outer cylinder 540, and no smaller, inner cylinder 530 may be needed. In this case, smaller, inner cylinder 530 may be absent.

In other embodiments of disposable cartridge 110, the inner cylinder 530 may be disposed inside the larger outer cylinder 540. The inner cylinder 530 may form a hollow area within the larger cylinder 540. The hollow inner cylinder 530 may, in turn, be the axle around which a supply of pet waste bags may be wound.

The hollow spool 530 may also be used to store and dispense pet treats, such that the disposable cartridge 110 may store and dispense both pet treats and pet waste collection bags 111. Pet waste collection bags 111 may be wrapped around the central hollow spool 530 which in turn stores the pet treats. In this configuration, the cartridge may become a dual use cartridge 110′ configured to hold both pet waste collection bags and pet treats. Either type of cartridge, single 110 use or dual use 110′, may have a lengthwise slot 520 in its side.

An exploded view of the dual use cartridge 110′ is shown in FIG. 5b. FIG. 5b shows the smaller, inner cylinder 530 in which the pet treats (not shown) may be stored, inside the larger, outer cylinder 540. The lengthwise slot 520 may dispense the pet waste bags, and the hole 550 in the flip cap 510 may dispense the pet treats, either individually or in small numbers. It should be understood that the flip cap 510 may be disposed on the underside of dual use cartridge 110′, such that the treats are dispensed by gravity. Accordingly, the end cap 560 may be disposed on the top of dual use cartridge 110′ rather than on the bottom.

A method for dispensing the bags may allow for convenient one handed deployment of individual waste collection bags from cylinder 110 or 110′. The lengthwise slot in cartridge 110 may be used to dispense individual waste collection bags, napkins or tissues. Alternatively, the materials may be dispensed through a hole in the top 550 or bottom or bottom flip cap 510 of the cartridge 110 or 110′.

As mentioned, the pet treats may be stored within and dispensed from the hollow cylinder 530. They may be dispensed individually for convenience, or the dispensing mechanism may dispense a number of treats as configured by the user. The internal shape of the hollow spool 530 may be that of a funnel with the narrow part at the bottom. This may line up individual treats in single file. Treats arranged in this way may more easily work with a dispensing mechanism for limiting the dispensing of treats to one treat at a time. This mechanism might include the plungers 140, 150, 210, 215 and flaps 225 and 260 shown above. One possible example of such a mechanism may include the addition of a narrow slot in the lower part of the possible funnel shape in the hollow spool 530 and an arm connected to the flap 225, 260. The arm might block all but the bottom pet treat from deploying when the flap opens the bottom of the pet treat spool.

The waste collection bags 111 may be loaded into the first sort 110 or dual type cartridge 110′ in such a way that they do not require a dispensing mechanism 140, 210 or 215. Pulling one bag 111 out of the cartridge 110 or 110′ may position the next bag for subsequent removal. The bags 111 might be made up of a continuous roll with perforations between bags to make removal of each individual bag a convenient one handed operation. Alternately, the single 110 or dual cartridge 110′ may require a dispensing mechanism 140, 210, 215 for the bags. This mechanism may dispense the bags by rotating the cartridge when the bag plunger is depressed or the waste bag dispenser 140, 210, 215 may need to be pressed to allow the internally stored roll of bags to rotate so the bags would be prevented from unraveling inadvertently until the dispenser lever 140, 210, 215 was pressed. The bags may be made from polyethylene plastic resin and may be transparent or opaque and of any color.

If the dual storage cartridge 110′ is used, then pet care systems 100 and 200 may have only one cartridge 110′. Additionally, if the dual type cartridge 110′ is included, the holding mechanism and the cartridge may be larger. It is possible that two dual type disposable cartridges 110′ may be used, one on each side of the system 100 or 200. One may contain waste bags 111 and treats while the other may contain napkins and candy, for example. It should be understood that pet treat cartridge 120 may be mixed and matched with pet waste cartridge 110 or dual use cartridge 110′ in any manner desired, and in any number. A plurality of cartridges may be held by a holding structure 205 or 170, and arranged in any orientation desired by the pet owner.

Cartridge 110 and 110′ may further comprise machine readable indicia 180 such as a bar code readable by a bar code reader or cell phone. The machine-readable 180 indicia may be read by a web- or internet-enabled device, such as a cell phone, smart phone, tablet or laptop computer. The bar code may point to information to assist the ordering of replacement cartridges by a user.

Another (third) type of single use cartridge 120 is described in FIG. 6. It may be used for the storage and dispensing of solid, individual items such as pet treats. It may be a cartridge or similar volume with a bottom 620. In the bottom 620 may be a hole or slot 610. Pet treats may be dispensed through this opening. It may be marked with a barcode 160 or other indicia for identification. Cartridge 110 may be made in a variety of sizes or shapes.

These cartridges, 110 and 120, may be disposable or they may be reused multiple times. If the cartridges are used multiple times they may be loaded by the user. For the purpose of loading, a cartridge may have a lid that snaps or screws into the cartridge or attaches in some other way. Treats, bags or any useful item may be loaded by the user into a cartridge.

The pet treats may be stored in cartridges 110 or 120 in a variety of flavors and scents or there may be a variety within an individual cartridge. Similarity of size of the treats may be conducive to their individual dispensing. The treats may not require refrigeration.

Any or all of these cartridges may be marked by a barcode, 180 and 160, or other indicia and would be readable by a bar code reader or cell phone, wherein the barcode points to information to assist the ordering of replacement cartridges by a user or for the retail purchase of replacement cartridges. More generally, the machine-readable 160 or 180 may be read by any web- or internet-enabled device, such as a cell phone, smart phone, tablet or laptop computer.

The sizes of the single or dual use waste bag cartridges 110 or 110′ may not be the same, and the single use pet treat cartridges 120 might be of a different size as well. It is possible that a variety of sizes would be made requiring a variety of systems 100 and 200 and their holding mechanisms 175, 250, and 255. The cartridges are shown in FIGS. 1-6 as approximately the same size but they may be of different sizes. They are shown with a round cylindrical shape but they may be any of a variety of shapes. The cartridges, 110, 110′ and 120 may be transparent or they may be color coded to indicate their size, compatibility with different sizes of systems 100 and 200. The color coding may be indicative of the flavors or smells of the pet treats.

Below is an exemplary method of manufacturing the pet care system illustrated in the foregoing FIGS. 1-6.

All of the various parts of pet care systems, 100 and 200 will require manufacture and or assembly. A variety of materials may be used for the manufacture of the parts described above. Different methods and materials may be used for different quantities of manufacture. For example for prototypes materials such as aluminum and or steel may be used. And entirely different materials and methods may be used, for example, for the main frame 170 of pet care system 100 or for the clam shell sides of pet care system 200. An exemplary manufacturing method will be described for pet care system 200. It should be understood that similar techniques may be used to manufacture pet care system 100. The exemplary materials used may reflect the manufacturing of production quantities. The materials and manufacture of all the parts will be described first, followed by an exemplary assembly protocol. It should be understood that this manufacturing method and materials are exemplary only, and that other methods may be used to make pet care systems 100 and 200. For example, as described below, the cartridges 110, 110′ and 120 may be made with plastic, but alternatively, they could be made using cardboard or other rigid, inexpensive material.

The manufacture/assembly method described here refers to a two-part clam shell design described above and illustrated in FIGS. 3 and 4. However, it should be understood that this approach is not necessary, and that pet care systems 100 and 200 may instead be made using a monolithic body rather than the two-part design described here.

The clamshell sides of the leash 220 and 230, the dispensing mechanisms 210, the holding mechanisms 250, and the leash spool of retractable spring mechanism 300 may all be injection molded from an appropriate plastic material, for example. The material choice may require a strong, tough and shock resistant plastic that may withstand cold temperatures without cracking or fracturing. One choice may be acrylonitrile butadiene styrene (ABS) plastic. ABS may be injection molded accurately enough for the clamshell (mirror image) parts used here. These and other parts such as the cartridges fit together with close tolerances. The dimensional accuracy and repeatability with injection molded plastics is more than adequate for the tolerances required for this embodiment. The cartridges 110 and 120, their end caps, 510, 550 and 620 and the hollow spool 530 may be made from a different material such as polyvinylchloride (PVC), chosen for its reduced cost and improved glueability since the cartridges may be mass produced. The cartridges may be slightly tapered so that they may be easily removed from an injection mold.

For this example, the assembly of the clamshell will be accomplished with screw fasteners and sonic welding. The single holding mechanism 250 may be sonic welded or glued to the right side 220 of the leash handle. Threaded metallic inserts may be fitted into molded shaped holes in five positions around the right side 220. Mating holes in side 230 with depressions for screw heads may allow the right side 230 to be attached at final assembly. The plunger or flap pet treat dispensing mechanism 210 may be attached to the holding mechanism 250 or to the flat fide 220 of the handle with screws. Flap 260 may be manufactured from a flexible elastomeric material so that it will ordinarily close the hole in the bottom of cartridge 110 and such that plunger 210 may temporarily flex it open allowing one treat to pass.

The cartridges may be assembled using glue, for example, to assemble plastic components. The hollow spool 530 may be glued to the bottom plate 510 in a jig and the bottom plate 510 may be glued in position on the bottom of the slightly tapered cylinder 540. The waste collection bags may be formed from a continuous polyethylene roll with multiple perforations between each bag. The appropriate number of bags may be formed into a roll and installed in the cartridge around the hollow spool 530 such that the first bag may protrude 5 mm through the slot in cartridge 110. Pet treats may be loaded into the hollow spool 530 and the top round cap 550 may be glued in place. The barcode that corresponds to the dual cartridge with the particular variety of treats may be attached automatically to the cartridge with a printed adhesive backed tape. Velcro® may be glued to the cartridge opposite the slot; Velcro® may be glued to the holding mechanism as well, forming an adequate bond while allowing easy installation and removal of the cartridges.

The leash for pet care system 200 may comprise an appropriate length of flexible webbing or metal chain, for example 6 meters. For the purposes of this exemplary description, a metal chain (or wire rope) may be used for the longer part of the leash and the shorter safety collar may be nylon webbing. A metallic wear ring may be placed in the aperture where the metal chain exits the main structure 220 and 230. Because the opening in the wear ring may be far smaller than either the crimped end or the swivel hook on the ends of the leash, the wear ring may be installed on the leash before it is assembled between the two halves 220 and 230. The chain may terminate with a small 2 mm crimp swaged on one end and with a swivel hook on the other end. A safety collar comprised of a 40 cm length of nylon webbing may attach to the swivel hook at the end of the metal chain and be attached to a brass bolt snap at its opposite end, the pet end of the leash. The connections in the nylon may be made with short sewn loops. The crimped end of the leash may be fitted to the leash retraction spring mechanism. The retractable spring may be fitted inside the leash spool, retraction spring mechanism 290. One end of the spring may fasten to the spool and the other to the left side 230 of the handle portion.

A brake and brake lock controls for the retraction spring mechanism may be installed in the same side and connected as necessary to the retraction spring mechanism 290. For simplicity, this mechanism is not shown in FIGS. 2-4. A mechanical clicker may be installed and an RFID tag may be glued in place inside the left side 230. The wear ring may be glued or fitted in place at the point where the leash exits the handle. The 10 mm hard point may be attached to side 230 near the bottom rear (by the heel of the user's hand). The sides 220 and 230 may be fastened together with an appropriate number of screws through side 230.

Below is an exemplary use of the pet care system illustrated in the foregoing FIGS. 1-6. This invention may increase the convenience of those who exercise, train or otherwise handle pets. The system described here may be a retractable pet leash with accessories added to improve convenience.

Consumable pet care materials such as waste collection bags and pet treats may be purchased in cartridges and attached to the pet care system. These cartridges may be easily removed. A variety of pet treats may be available for purchase. Pet waste collection bags and treats may be conveniently dispensed from the cartridge with one hand when walking or training pets. The length of the leash may be controlled so that the leash could be short for training purposes or longer for other types of pet exercise. When used for training, the clicker may be used. The brake which controls the length of leash may be operated by the user's thumb. It may be capable of overcoming the pull of the pet and stopping the leash from exiting the handle. A second button on the rear of the handle may lock the leash length. The retractable spring may force all of the leash but the safety collar beyond the swivel hook into the leash handle where it can be stored. The safety collar, the last 40 centimeters of the leash, may be attached both around the pet's neck and to the pet's collar for added security.

Before leaving home, the pet owner may verify that treat cartridge 120 and waste bag cartridge 110 contain an adequate amount of supplies for the anticipated outing. The owner may refill the cartridges or obtain new cartridges which then fit in the pet care system 100 or 200. Upon exiting the car or house, the user may attach the leash to the collar of the pet. The pet owner may then allow an adequate length of leash to be dispensed from the spring-loaded spool mechanism, allowing the pet a range of unrestricted motion. When the owner wants to get the attention of the pet or restrain it further with the leash, the owner may activate the audible clicker, siren, whistle or alarm. Upon the return of the pet to the owner, the owner may reward the pet for this behavior by dispensing a treat and feeding it to the pet. Another sound of the whistle, clicker, siren or alarm may be used by the owner to indicate that the outing is over and that the pet is to return to the control of the owner for transport home.

In the event that the owner loses control of the pet and pet care system 100 or 200, the owner may be able to locate the pet using the GPS locator in communication with, for example, a smart phone.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Furthermore, details related to the specific methods are intended to be illustrative only, and the invention is not limited to such embodiments. Accordingly, the exemplary implementations set forth above, are intended to be illustrative, not limiting.

What is claimed is:

1. A pet care system, comprising:
a structure with a holding mechanism;
a disposable cartridge that is held by the holding mechanism but is removable from the holding mechanism; and
consumable pet care materials stored in the disposable cartridge, wherein the disposable cartridge is configured to dispense the consumable pet care materials.

2. The pet care system of claim 1, wherein the consumable pet care materials comprise at least one of pet waste collection bags and pet treats.

3. The pet care system of claim 1, wherein the structure is attachable to at least one of a user, an article of clothing and a pet.

4. The pet care system of claim 1, further comprising: a retractable, flexible leash that may be stored in the structure and dispensed from the structure, and may also be attached to a collar of a pet.

5. The pet care system of claim 1, further comprising: a coupling mechanism that couples the pet care system to at least one of a user's person and a stationary object.

6. The pet care system of claim 1, further comprising: at least one of an RFID tag, a radio transmitter, a radio receiver, a UPS locator, a mechanism for generating audible sounds, a light emitting diode, and a flashlight.

7. The pet care system of claim 6, wherein the at least one of the REID tag, the radio transmitter, the radio receiver, the GPS locator, the mechanism for generating audible sounds, the light emitting diode and the flashlight is in communication with a transmitter or receiver in a user's possession.

8. The pet care system of claim 6, further comprising: a battery for powering at least one of the RFID tag, the radio transmitter, the radio receiver, the GPS locator, the mechanism for generating audible sounds, the light emitting diode and the flashlight.

9. The pet care system of claim 1, wherein the disposable cartridge is configured to hold both the pet waste collection bags and the pet treats.

10. The pet care system of claim 9, wherein the pet waste disposal bags are wound around a hollow spool, and wherein the hollow spool contains the pet treats.

11. The pet care system of claim 1, wherein the structure further comprises a plurality of holding mechanism for holding a plurality of disposable cartridges.

12. The pet care system of claim 11, wherein the disposable cartridge contains pet waste collection bags and the second disposable cartridge contains pet treats.

13. The pet care system of claim 1, wherein the structure is comprised of two portions which are coupled together in a dam shell fashion.

14. The pet care system of claim 14, wherein the structure further comprises two holding mechanisms, one on each of the two portions, which are configured to securely hold two disposable cartridges for dispensing the consumable pet care materials.

15. The pet care system of claim 1, wherein the holding mechanism includes a lever that dispenses the consumable pet care materials from the disposable cartridge.

16. The pet care system of claim 1, wherein the holding mechanism includes a flip cap that exposes and dispenses the consumable pet care materials from the disposable cartridge.

17. The pet care system of claim 1, further comprising: a bar code readable by at least one of a barcode reader and an internet-enabled device.

18. The pet care system of claim 17, wherein the barcode contains information to assist the ordering of replacement cartridges by a user.

19. The pet care system of claim 1, wherein the structure has no dimension in excess of about 8 inches, and is configured to be hand-held.

20. The pet care system of claim 6, wherein the mechanism for generating audible sounds generates at least one of a clicker, a whistle, and a siren.
